(19) United States
(12) Patent Application Publication
(10) Pub. No.: US 2017/0097920 A1
(43) Pub. Date: Apr. 6, 2017

(54) HIGH FIDELITY CONTENT UNIFICATION ACROSS CONTENT OF DOCUMENT

(71) Applicant: Microsoft Technology Licensing, LLC, Redmond, WA (US)

(72) Inventors: Ye Zhang, Redmond, WA (US); Yamin Wang, Redmond, WA (US); Eduardo Melo, Redmond, WA (US); Luis Efrain Regalado De Loera, Bellevue, WA (US)

(21) Appl. No.: 14/874,356

(22) Filed: Oct. 2, 2015

(51) Int. Cl. G06F 17/21; G06F 17/24; G06F 17/22; G06F 17/27

(52) U.S. Cl. CPC G06F 17/211; G06F 17/272; G06F 17/243; G06F 17/2247

(57) ABSTRACT

A high fidelity content unification is provided across a content of a document. An application, such as a communication application, identities a global style applied to a document. The global style includes a CSS formatting content portions of the document. The global style is matched to the content portions of the document by a style parser. The global style is then applied as a local style to the content portions that match the global style. The global style is removed from the document to preserve styles of new content portions.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications provide content management. Global styles associated with a document are prone to overwrite styles of new content portions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a high fidelity content unification across a content of a document. In some examples, a communication application may identify a global style applied to a document. The global style may be matched to content portions of the document. Next, the global style may be applied as a local style to the content portions. Furthermore, the global style may be removed from the document.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is an architectural diagram illustrating an example of providing a high fidelity content unification across a content of a document, according to embodiments;

FIGS. 2A and 2B are display diagrams illustrating examples of a global style altering a style of a new content and a local style preserving the style of the new content, according to embodiments;

FIG. 3 is a display diagram illustrating a communication application processing a content portion to replace a global style associated with the content portion with a local style, according to embodiments;

FIG. 4 is a display diagram illustrating a communication application processing content portions of a document to replace a global style associated with the content portions with a local style, according to embodiments;

FIG. 5 is a simplified networked environment, where a system according to embodiments may be implemented;

FIG. 6 is a block diagram of an example computing device, which may be used to provide a high fidelity content unification across content of a document; and

FIG. 7 is a logic flow diagram illustrating a process for providing a high fidelity content unification across content of a document, according to embodiments.

### DETAILED DESCRIPTION

As briefly described above, a high fidelity content unification may be provided across a content of a document by a communication application. The communication application may identify a global style applied to one or more content portions of a document. The global style may include a cascading style sheet (CSS). The CSS may be parsed by processing hypertext markup language (HTML) formatted content portions of the document through a style parser.

Next, the global style may be matched to the content portions of the document. The content portions may include a text, a graphic, an image, a video stream, an audio stream, and/or an animation, among others. The global style may be applied as a local style to the content portions. For example, the CSS identified as the global style may be attached to the content portions as a local style. Furthermore, the global style may be removed from the document to prevent the global style from modifying a style of a subsequent content that may be added to the document.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide a high fidelity content unification across content of a document. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

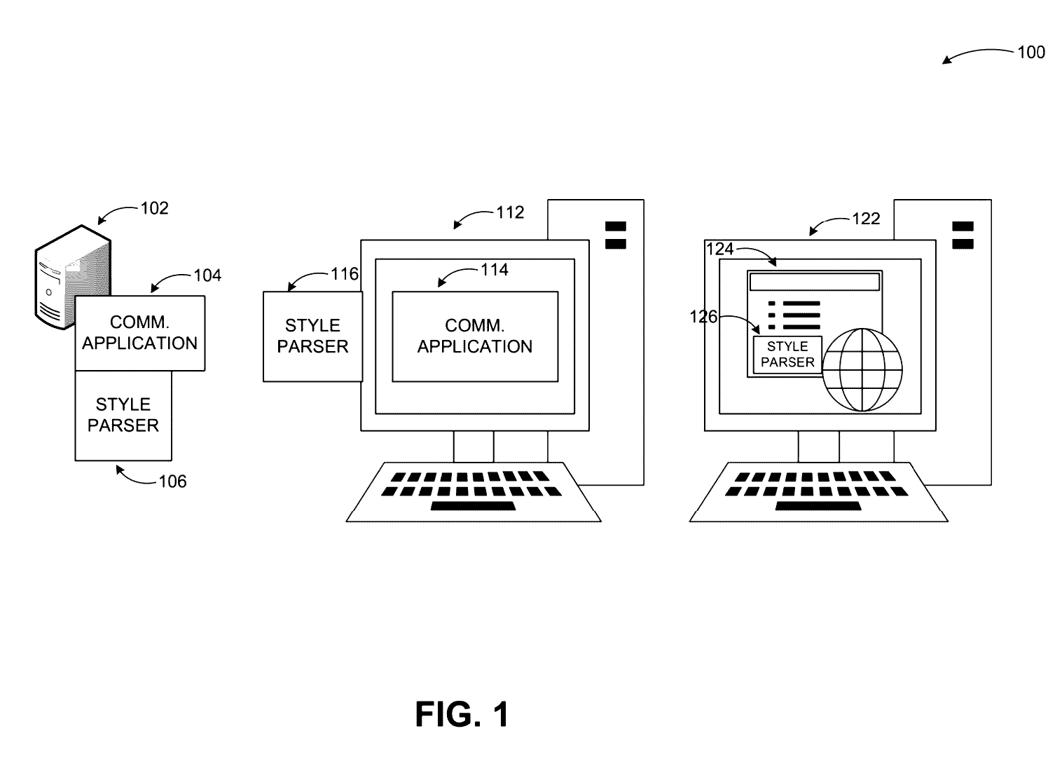

FIG. 1 is an architectural diagram illustrating an example of providing a high fidelity content unification across a content of a document, according to embodiments.

In a diagram 100, a computing device 102 may execute a communication application 104. The computing device 102 may include a physical server, a server farm, a data warehouse, and/or a data center, among others. The communication application 104 may include a messaging application, an email processing application and/or a document processing application, among others. The communication application 104 may process content portions of a document through a style parser 106 to match a global style of the document to the content portions. If left in the document, the global style may alter a style of a new content that may be merged with the document in the future. The global style may include a CSS that describes format attributes to be applied to the content portions. Examples of format attributes are extensive. A limited example include font attributes, background attributes, foreground attributes, and/or size and color attributes, among others. The content portions may include a section of text (such as a sentence, and/or a paragraph, among others), an image, a graphic, an animation, a video stream, and/or an audio stream, among others. The style parser 106 may be a component of the communication application 104 similar to an html parser used by a browser to process html content. The style parser 106 may also be provided by an external provider such as a web service. The global style matched to content portions may be replaced with a local style to prevent the global style from modifying a style of new content to be added to the document.

In an example of an alternative architecture, the communication application 114 may be provided as a thick client application. The thick client application may process computations associated with presented data locally. The data may be managed locally or retrieved from an external provider. An example of a thick client application may include an email processing application, and/or a document processing application, among others. The communication application 114 may be executed by a computing device 112. The computing device 112 may include a tablet, a smart phone, a notebook computer, and/or a desktop computer, among others. The communication application 114 may process a document through a style parser 116 to match a global style of a document to content portions of the document. The style parser 116 may be hosted by the computing device 112 or provided by an external provider such as a web service. The matched global style may be replaced with a local style to prevent the global style from modifying a style of new content to be merged with the document.

In an example of another alternative architecture, the communication application 124 may be provided as a web browser executed by a computing device 122. The web browser may include a style parser 126 to process content of documents such as HTML formatted web pages or messages such as HTML formatted emails, among others. An example of a document may include a conversation of emails with components formatted by a global style such as a CSS. For example, a web based email application may process a conversation of emails that may include a global CSS applied to header sections (such as sender and/or subject, among others) to render the header sections in bold style font. The communication application 124 may replace the global style with a local style to prevent the global style from affecting subsequent content added to the document to prevent a rendition of the added content in bold style font. An example of added content may include new emails added to the conversation.

The computing device 102, 112, or 122 may communicate with other devices such as the content providers through a network. The network may provide wired or wireless communications between nodes such as the computing device 102, 112, or 122, among others.

A document author or a collaborator of a document may interact with user interfaces of the communication application 104, 114, or 124 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 102, 112, or 122 and/or the communication application 104, 114, or 124, embodiments are not limited to these components or system configurations and can be implemented with other system configuration employing fewer or additional components.

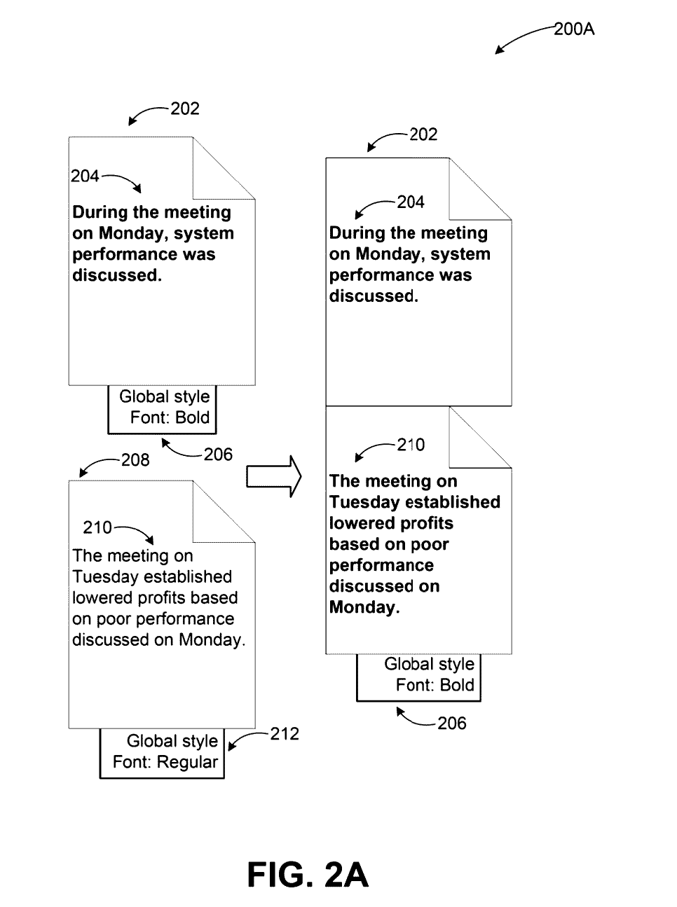

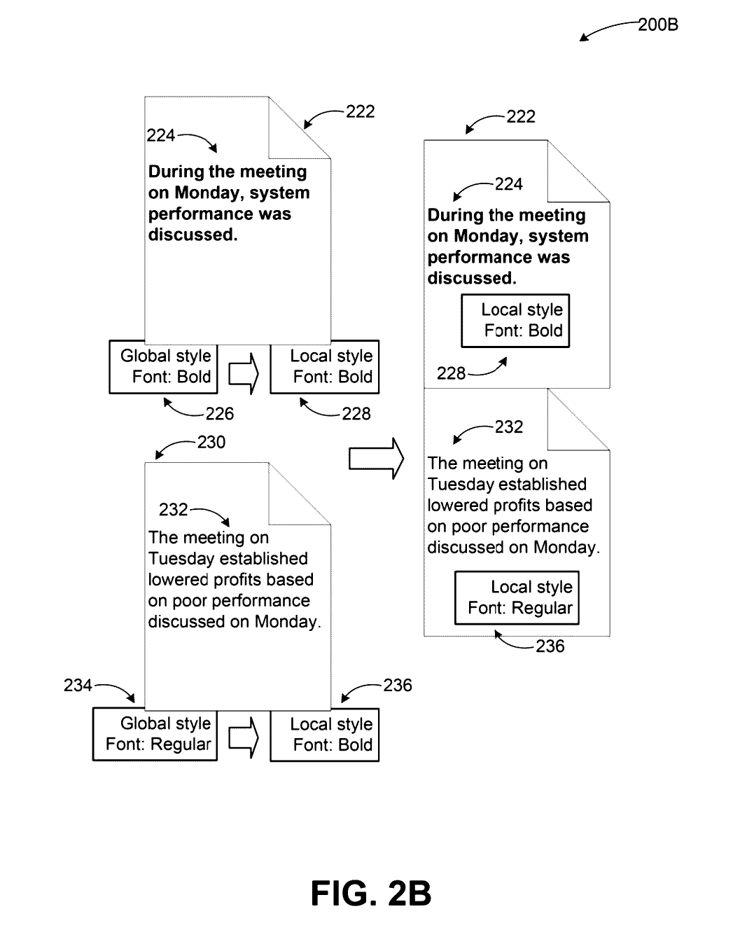

FIGS. 2A and 2B are display diagrams illustrating examples of a global style altering a style of a new content and a local style preserving the style of the new content, according to embodiments.

In a diagram 200A, an example illustrates unification of document content in which a global style 206 of a content portion 204 modifies a global style 212 of a content portion 210. A communication application may manage and present a document 202 that may include the content portion 204. The content portion 204 may be formatted based on the global style 206. The global style 206 may cause the content portion 204 to be rendered in a bold type font.

Next, the communication application may detect an attempt to merge a document 208 with the document 202. The document 208 may include the content portion 210 that may be formatted based on the global style 212. The global style 212 may cause the content portion 210 to be rendered in a regular type font.

In response to the attempt to merge the document 208 with the document 202, the communication application may apply the global style 206 to the content portion 210. As such, the global style 212 of the content portion 210 may not be preserved and the global style 206 may modify the global style 212 of the content portion 210 by converting a regular font type to a bold font type. As such, the global style 206 applied to the document 202 may overwrite an author's wish to preserve the global style 212 of the content portion 210.

In a diagram 200B, an example illustrates unification of document content while preserving local style. A communication application may process a content portion 224 of a document 222 to match a global style 226 to the content portion 224. The global style 226 may be replaced by a local style 228 by applying the global style 226 as the local style 228 to the content portion 224 and removing the global style 226.

Next, an attempt to merge the document 222 with a document 230 may be detected. The communication application may process a content portion 232 to match a global style 234 of the document 230 to the content portion 232. The global style 234 may be replaced by a local style 236, which is applied to the content portion 232. Subsequently, the content portion 232 may be merged with the document 222. However, unlike the scheme illustrated in the diagram 200A, the local style 236 applied to the content portion 232 may preserve the original style of the content portion 232 as defined by the global style 234 in the document 230. As such, an author's wish to preserve the original style of the content portion 232 may be fulfilled by applying the global styles 234 as the local style 236 to the content portion 232. The local style 236 of the content portion 232 is preserved in the document 222 because the local style 228 does not affect the local style 236 (or vice versa) compared to the modification behavior of global styles to overwrite styles of subsequently added content.

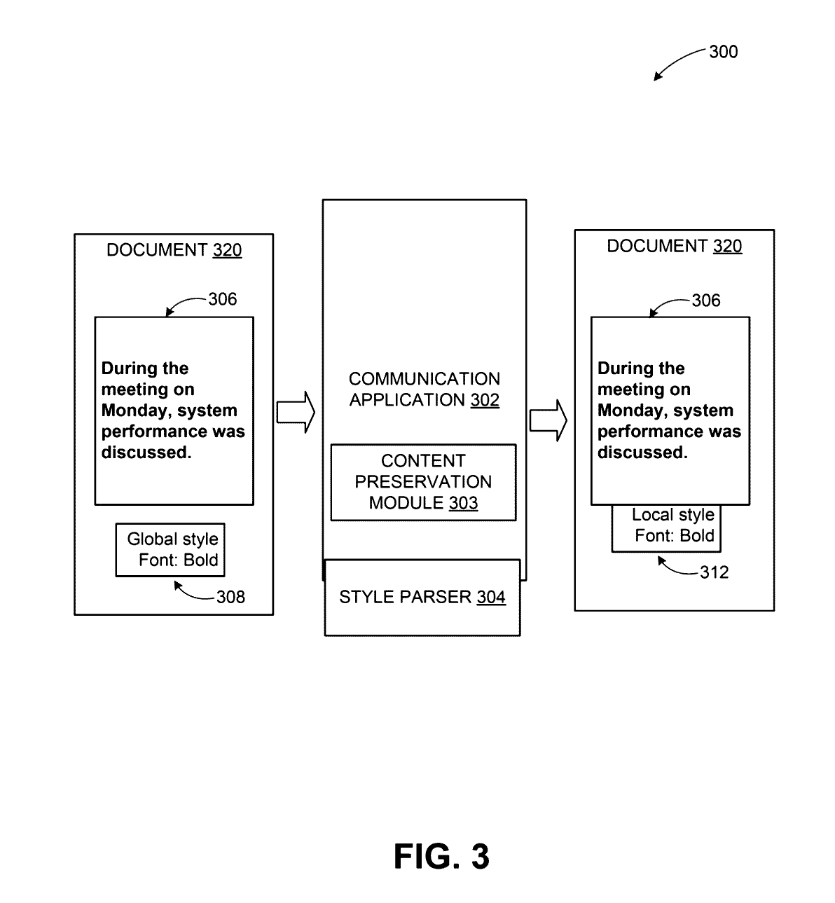

FIG. 3 is a display diagram illustrating an example of a communication application processing a content portion to replace a global style associated with the content portion with a local style, according to embodiments.

In a diagram 300, a communication application 302 may process a content portion 306 to remove a global style 308. The content portion 306 may be part of a document 320 such as a text based document, a web page, a presentation, and/or an email conversation, among others. The content portion 306 may be formatted with a global style 308 such as CSS. A CSS may include formatting attributes that define how the content portion 306 may be formatted.

The global style 308 of the document 320 may be identified by a style parser 304 associated with the communication application 302. The style parser 304 may be a module with functionality to parse content and decipher formatting such as HTML. For example, a web browser includes a style parser to parse content formatted with HTML. The style parser 304 may match the global style 308 to the content portion 306.

Next, the style parser 304 may provide the global style 308 matched to the content portion 306 to a content preservation module 303 for processing. The content preservation module 303 may apply the global style 308 as a local style 312 to the content portion 306. Subsequently, the global style 308 may be removed from the document 320. When the global style 308 is removed from the document 320, it may not modify subsequent additions of content portions into the document 320 or overwrite styles associated with the new content portions. The style of the content portion 306 may also be preserved through the local style 312, which may maintain formatting attributes applied to the content portion 306 by the global style 308.

Alternatively, the global style 308 applied to the document 320 may be compared with a default style associated with the document 320. The global style 308 may include a CSS. The default style may include a CSS. In response to detecting one or more variances between the global style and the default style, the local style 312 may be generated from the variances. The local style 312 may also be generated by combining the variances with the default style.

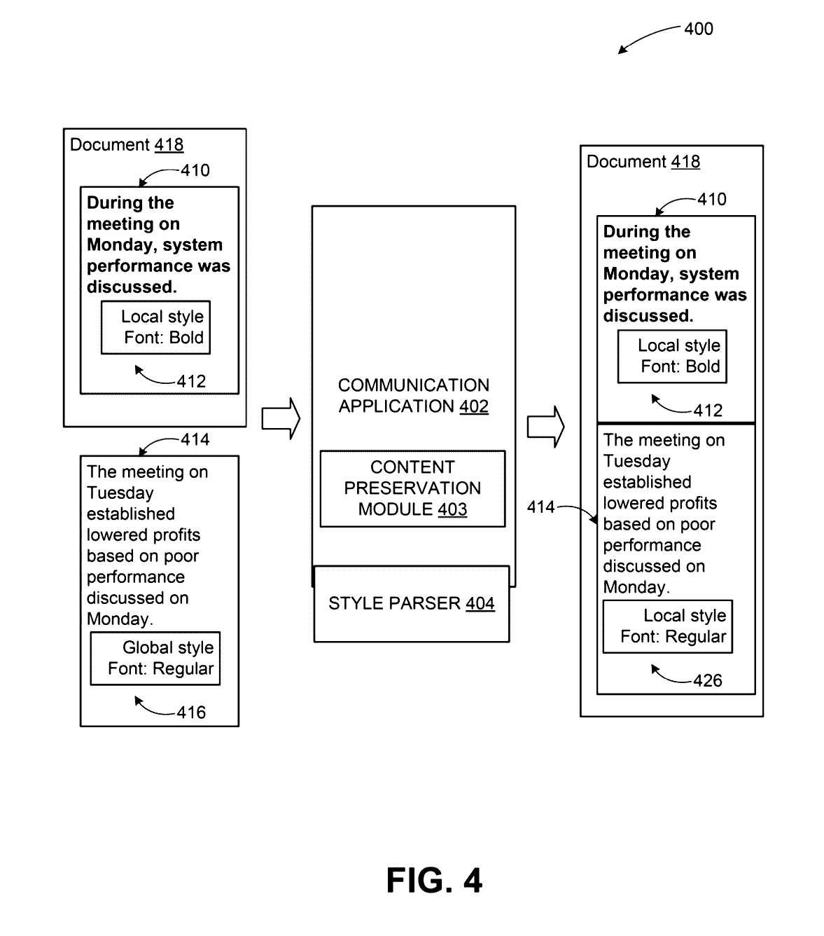

FIG. 4 is a display diagram illustrating an example of a communication application processing content portions of a document to replace a global style associated with the content portions with a local style, according to embodiments.

In a diagram 400, a document 418 may be processed by the communication application 402 to replace all global styles with local styles. Global styles may overwrite a style of a new content portion that may be added to the document 418. As such, a global style may be replaced with a local style that preserves formatting of the associated content portion and does not modify the formatting of another content portion. An example of the document 418 may include a collaboration document such as a conversation of emails in which one or more senders grow a conversation of the emails with reply emails that preserve local style and do not modify a style of a previous or a subsequent reply email.

The document 418 may include a content portion 410 with a local style 412 that defines formatting for the content portion 410. For example, the local style 412 may define a bold font type for the content portion 410. Next, an attempt to insert a content portion 414 into the document 418 may be detected. The content portion 414 may have a global style 416 that may modify the local style 412 of the content portion 410 (e.g., modify to regular font type) if left unprocessed.

The communication application 402 may process the content portion 414 with a style parser 404. The style parser may detect the global style 416 associated with the content portion 414 and match the global style 416 to the content portion 414. The global style 416 (that is matched to the content portion 414) may be provided to a content preservation module 403 for processing. The content preservation module 403 may apply the global style 416 as a local style 426 to the content portion 414. Furthermore, the global style 416 may be removed. After the application of the local style 426 to the content portion 414, the content portion 414 may be merged with the document 418. The local style 412 of the content portion 410 and the local style 426 of the content portion 414 may be preserved during the merge operation. As such, a wish of an author (a collaborator) of the document 418 and a wish of the same or another author (the same or another collaborator) to preserve the local style 412 and the global style 416 associated with the respective content portions may be fulfilled by replacing the global style 416 with the local style 426 while merging the content portions in the document 418.

A scheme to preserve a style such as a CSS applied to a content portion may be illustrated with operations. The following descriptions of operations provide a non-limiting example of preserving the style of content portions by replacing global styles with local styles

```
/// <param name=“content”>html content to be processed</param>
/// <returns>The result</returns>
public static jQueryObject ConvertInlineCSS(string content)
{
    jQueryObject result = null;
  try
    {
```

IFrameElement tempIframe =

(IFrameElement)Document.CreateElement(“iframe”);

```
  tempIframe.Style.Display = CSSValues.None;
  Document.Body.AppendChild(tempIframe);
  DOMDocument iframeDocument = null;
  if (tempIframe.ContentDocument != null)
  {
```

iframeDocument = tempIframe.ContentDocument;

```
  }
  else if (tempIframe.ContentWindow != null)
  {
```

iframeDocument = tempIframe.ContentWindow.Document;

```
  }
  if (iframeDocument != null)
  {
```

iframeDocumentOpen( );
if (content.IndexOf(InlineCSSConverter.DocTypeConstant) != 0)
{
content = InlineCSSConverter.DocTypeConstant + content;
}
iframeDocument.Write(content);
iframeDocument.Close( );
DOMElement bodyElement =

jQuery.FromElement(iframeDocument.DocumentElement).Find(“body”).GetElement(0);

bodyElement = ExtendedDocument.ImportNode(bodyElement, true);
result = jQuery.FromElement(bodyElement);
ExtendedDocumentInstance extendedDocument =

(ExtendedDocumentInstance)(object)iframeDocument;

if (extendedDocument.StyleSheets != null)
{
foreach (CssStyleSheet cssStyleSheet in

extendedDocument.StyleSheets) <<< a. Get all global styles from message

{

object[ ] cssRules = cssStyleSheet.CssRules;
if (cssRules != null && cssRules.Length > 0)
{

foreach (StyleRule styleRule in cssRules) <<< b. For each global style

{

```
if (!_Script.IsNullOrUndefined(styleRule.SelectorText) &&
  styleRule.SelectorText.IndexOf(“hover”) == −1)
{
  if
```

(styleRule.CssText.Match(InlineCSSConverter.GlobalPStyleMatchingRegEx) = null &&
styleRule.CssText.Match(InlineCSSConverter.PagedMediaMatchingRegEx) == null)

{

result.Find(styleRule.SelectorText).Each(delegate(int index,

DOMElement element) <<< c. Get the collection of elements on which the style applies

{

element.Style.CssText += styleRule.Style.CssText; <<< d. For

each of the element, attach the global style definition—and thus convert it to local style

element.RemoveAttribute(“class”);
});

}
}

}
}

}
}

result.Find(“style”).Remove( ); <<< e. Delete all global styles

Document.Body.RemoveChild(tempIframe);
tempIframe = null;

```
  }
}
catch (Exception ex)
{
  result = InlineCSSConverter.ConvertInlineCSSFallback(content);
  Trace.LogWarning(OwaTraceComponent.Editor, “Exception encountered
```

on Inline CSS conversion. error: {0}”, ex.Message);

}
return result;

}

As discussed above, the application may be employed to perform operations associated with providing a high fidelity content unification across a content of a document. An increased user efficiency with the communication application (104, 114, or 124) may occur as a result of preserving a style of a content portion while merging the content to a document with content portions of varying styles. Additionally, replacement of a global style with a local style to preserve an original style of a content portion of a document by a communication application (104, 114, or 124) may reduce processor load, increase processing speed, conserve memory, and reduce network bandwidth usage.

Embodiments, as described herein, address a need that arises from a lack of efficiency between an author and a collaborator interacting with the communication application (104, 114, or 124) of the computing device (102, 112, or 122). The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing a high fidelity content unification across a content of a document may be implemented in configurations employing fewer or additional components in applications and user interfaces. Furthermore, the example schema and components shown in FIG. 1 through 4 and their subcomponents may be implemented in a similar manner with other values using the principles described herein.

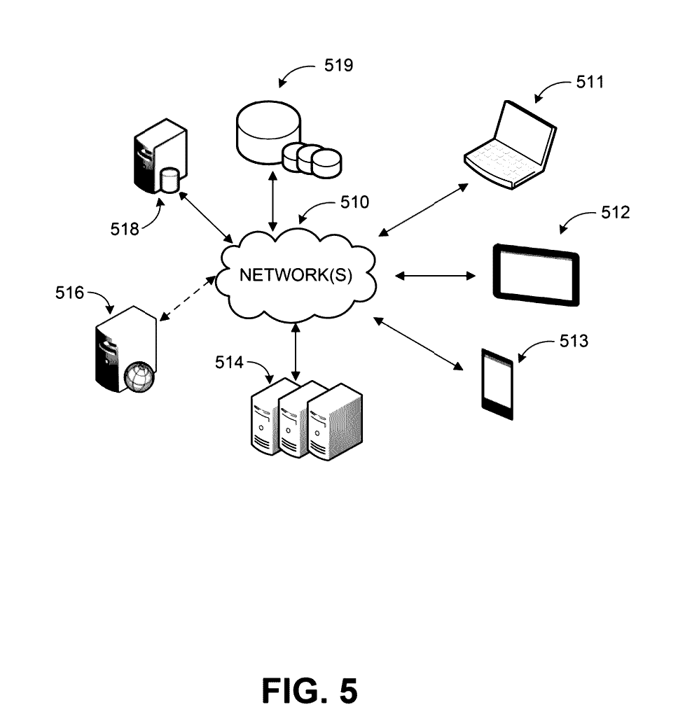

FIG. 5 is an example networked environment, where embodiments may be implemented. A communication application configured to provide a high fidelity content unification across a content of a document may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A communication application may identify a global style applied to a document. The global style may matched to content portions of the document. The global style may be applied as a local style to the content portions and the global style may be removed from the document. The communication application may store data associated with the document in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a high fidelity content unification across a content of a document. Furthermore, the networked environments discussed in FIG. 5 are for illustration purposes only. Embodiments are not limited to the example applications, modules, or processes.

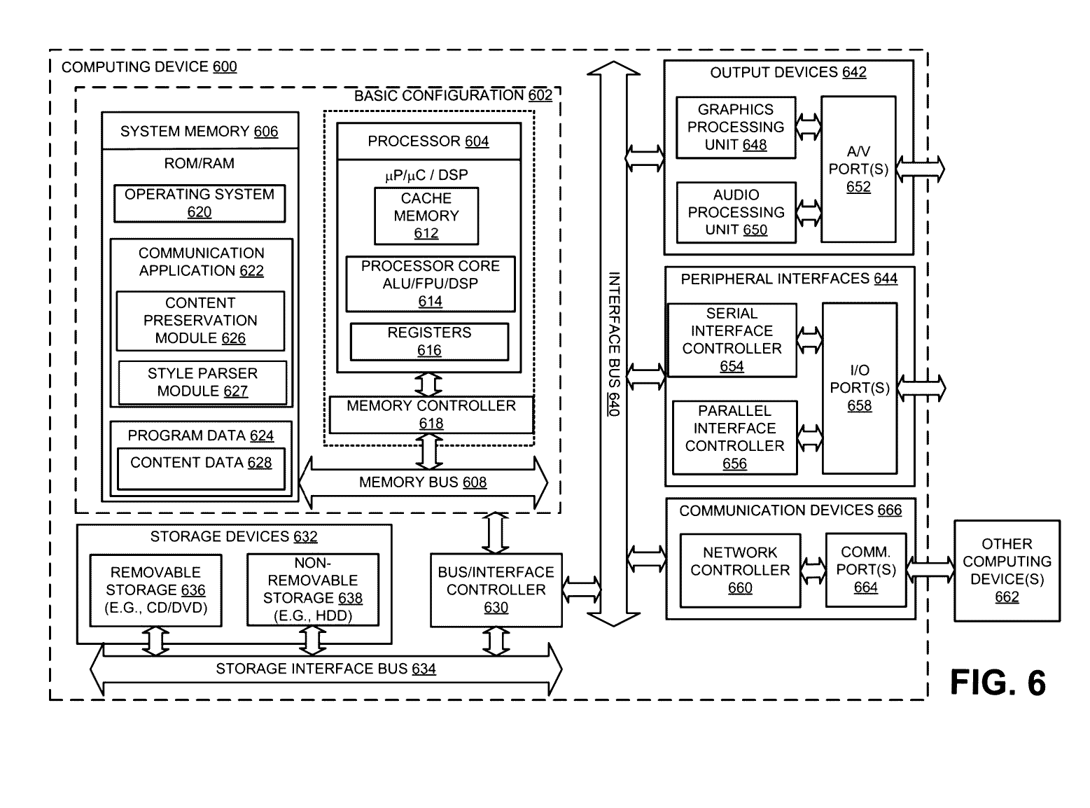

FIG. 6 is a block diagram of an example computing device, which may be used to provide a high fidelity content unification across a content of a document.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication application 622, and a program data 624. The communication application 622 may include components such as a content preservation module 626 and a style parser module 627. The content preservation module 626 and the style parser module 627 may execute the processes associated with the communication application 622. The style preservation module 627 may identify a global style applied to a document. The global style may be matched to content portions of the document. The content preservation module 626 may apply the global style as a local style to the content portions and remove the global style from the document.

A component of the computing device 600, a communication device may be used by the computing device 600 to receive input and transmit output associated with the communication application 622. The program data 624 may also include, among other data, content data 628, or the like, as described herein. The content data 628 may include global and local styles such as a CSS, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide a high fidelity content unification across a content of a document. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

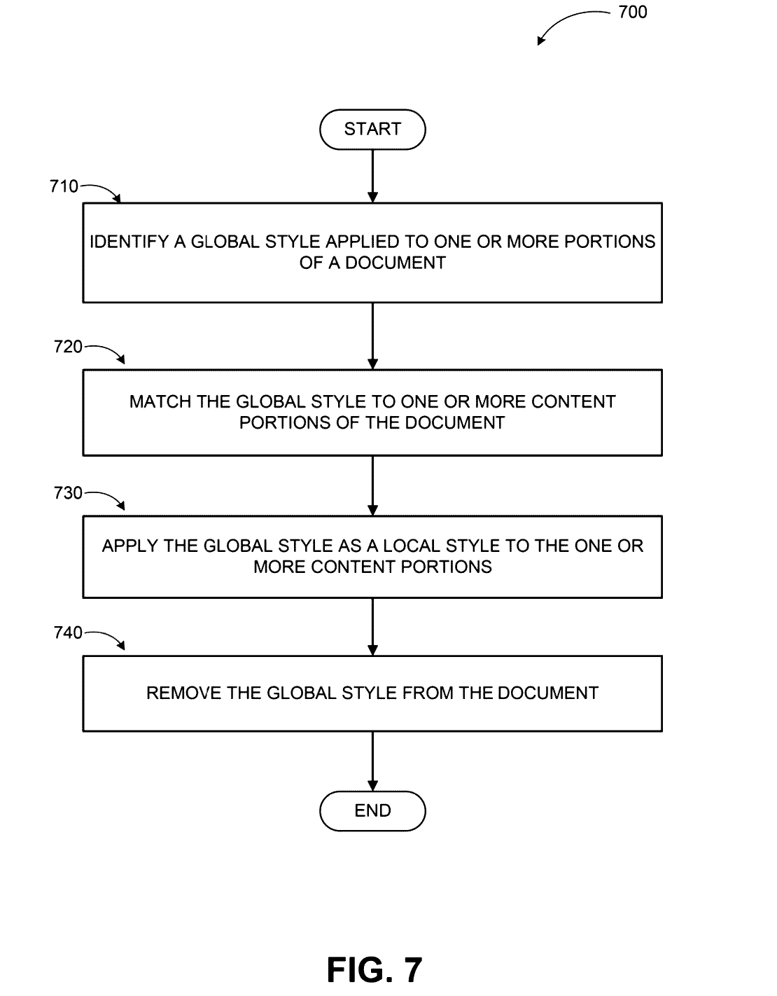

FIG. 7 is a logic flow diagram illustrating a process for providing a high fidelity content unification across a content of a document e, according to embodiments. Process 700 may be implemented on a computing device, such as the computing device 600 or another system.

Process 700 begins with operation 710, where a communication application may identify a global style applied to a document. The global style may include a CSS. The document may include a conversation of emails. At operation 720, the global style may be matched to content portions of the document. A style parser may parse HTML formatting of the content portions and match the global style to the content portions.

At operation 730, the global style may be applied as a local style to the content portions. The local style may provide formatting limited to an associated content portion. At operation 740, the global style may be removed from the document. The removal of the global style may prevent an alteration of a style of a new content portion by the global style, which may overwrite the style of the new content portion.

The operations included in process 700 are for illustration purposes. Providing a high fidelity content unification across a content of a document may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device for providing a high fidelity content unification across a content of a document may be described. The computing device may include a communication device, a memory configured to store instructions associated with a communication application, and one or more processors coupled to the memory and the communication device. The one or more processors may execute the communication application in conjunction with the instructions stored in the memory. The communication application may include a style parser module and a content preservation module. The style parser module is configured to identify a global style applied to a document and match the global style to one or more content portions of the document. The content preservation module is configured to apply the global style as a local style to the one or more content portions and remove the global style from the document.

According to other examples, the content preservation module is further configured to detect an attempt to insert a new content portion in to the document and provide the new content portion to the style parser module. The style parser module is further configured to identify another global style applied to the new content portion, match the other global style to the new content portion, and provide the other global style as matched to the new content portion to the content preservation module. The content preservation module is further configured to apply the other global style as another local style to the new content portion, remove the other global style from the new content portion, and insert the new content portion into the document.

According to further examples, the content preservation module is further configured to detect an attempt to one or more of insert and merge a new document with the document and provide the new document to the style parser module. The style parser module is further configured to identify another global style applied to one or more other content portions of the new document, match the other global style to the one or more other content portions, and provide the other matched global style as matched to the one or more other content portions to the content preservation module. The content preservation module is further configured to apply the other global style as another local style to the one or more other content portions, remove the other global style from the new document, and one or more of: insert and merge the new document with the document.

According to other examples, the style parser module is further configured to transmit the one or more content portions to a hypertext markup language (HTML) parser, receive a cascading style sheet (CSS) as the global style matched to the one or more content portions from the HTML parser, and provide the CSS as the global style to the content preservation module. The content preservation module is further configured to apply the CSS as the local style to the one or more content portions. The style parser module is further configured to process the one or more content portions to parse a hypertext markup language (HTML) format of the one or more content portions, identify a cascading style sheet (CSS) as the global style matched to the one or more content portions, and provide the CSS as the global style to the content preservation module. The content preservation module is further configured to apply the CSS as the local style to the one or more content portions.

According to some examples, a method executed on a computing device for providing a high fidelity content unification across a content of a document. The method may include identifying a global cascading style sheet (CSS) applied to a collaboration document, matching the global CSS to one or more content portions of the collaboration document, applying the global CSS as a local CSS to the one or more content portions, and removing the global CSS from the collaboration document.

According to other examples, the method may further include comparing the global CSS applied to the collaboration document with a default CSS associated with the collaboration document and detecting one or more variances between the global CSS and the default CSS. The local CSS may be generated form the one or more variances. The local CSS may be generated from the one or more variances and the default CSS. The collaboration document may include a conversation of one or more messages between one or more collaborators. The global CSS may be identified within a hypertext markup language (HTML) formatting of the one or more content portions.

According to some examples, a computer-readable memory device with instructions stored thereon for providing a high fidelity content unification across a content of a document may be described. The instructions may include actions that are similar to the method described above.

According to some examples, a means for providing a high fidelity content unification across a content of a document may be described. The means for providing a high fidelity content unification across a content of a document may include a means for identifying a global style applied to a document, a means for matching the global style to one or more content portions of the document, a means for applying the global style as a local style to the one or more content portions and a means for removing the global style from the document.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing a high fidelity content unification across a content of a document, the computing device comprising:
a communication device;
a memory configured to store instructions associated with a communication application;
one or more processors coupled to the memory and the communication device, the one or more processors executing the communication application in conjunction with the instructions stored in the memory, wherein the communication application includes:
a style parser module configured to:
identify a global style applied to a document;
match the global style to one or more content portions of the document; and
a content preservation module configured to:
apply the global style as a local style to the one or more content portions; and
remove the global style from the document.

2. The computing device of claim 1, wherein the content preservation module is further configured to:
detect an attempt to insert a new content portion in to the document; and
provide the new content portion to the style parser module.

3. The computing device of claim 2, wherein the style parser module is further configured to:
identify another global style applied to the new content portion;
match the other global style to the new content portion; and
provide the other global style as matched to the new content portion to the content preservation module.

4. The computing device of claim 3, wherein the content preservation module is further configured to:
apply the other global style as another local style to the new content portion;
remove the other global style from the new content portion; and
insert the new content portion into the document.

5. The computing device of claim 1, wherein the content preservation module is further configured to:
detect an attempt to one or more of: insert and merge a new document with the document; and
provide the new document to the style parser module.

6. The computing device of claim 5, wherein the style parser module is further configured to:
identify another global style applied to one or more other content portions of the new document;
match the other global style to the one or more other content portions; and
provide the other matched global style as matched to the one or more other content portions to the content preservation module.

7. The computing device of claim 6, wherein the content preservation module is further configured to:
apply the other global style as another local style to the one or more other content portions;
remove the other global style from the new document; and
one or more of: insert and merge the new document with the document.

8. The computing device of claim 1, wherein the style parser module is further configured to:
transmit the one or more content portions to a hypertext markup language (HITML) parser; and
receive a cascading style sheet (CSS) as the global style matched to the one or more content portions from the HTML parser; and
provide the CSS as the global style to the content preservation module.

9. The computing device of claim 8, wherein the content preservation module is further configured to:
apply the CSS as the local style to the one or more content portions.

10. The computing device of claim 1, wherein the style parser module is further configured to:
process the one or more content portions to parse a hypertext markup language (HTML) format of the one or more content portions;
identify a cascading style sheet (CSS) as the global style matched to the one or more content portions; and
provide the CSS as the global style to the content preservation module.

11. The computing device of claim 10, wherein the content preservation module is further configured to:
apply the CSS as the local style to the one or more content portions.

12. A method executed on a computing device for providing a high fidelity content unification across a content of a document, the method comprising:
identifying a global cascading style sheet (CSS) applied to a collaboration document;
matching the global CSS to one or more content portions of the collaboration document;
applying the global CSS as a local CSS to the one or more content portions; and
removing the global CSS from the collaboration document.

13. The method of claim 12, further comprising:
comparing the global CSS applied to the collaboration document with a default CSS associated with the collaboration document; and
detecting one or more variances between the global CSS and the default CSS.

14. The method of claim 13, further comprising:
generating the local CSS from the one or more variances.

15. The method of claim 13, further comprising:
generating the local CSS from the one or more variances and the default CSS.

16. The method of claim 12, wherein the collaboration document includes a conversation of one or more messages between one or more collaborators.

17. The method of claim 12, wherein the global CSS is identified within a hypertext markup language (HTML) formatting of the one or more content portions.

18. A computer-readable memory device with instructions stored thereon for providing a high fidelity content unification across a content ofa document, the instructions comprising:
identifying a global cascading style sheet (CSS) applied to a collaboration document;
matching the global CSS to one or more content portions of the collaboration document;
applying the global CSS as a local CSS to the one or more content portions; and
removing the global CSS from the collaboration document.

19. The computer-readable memory device of claim 18, wherein the instructions further comprise:
detecting an attempt to merge a new document with the document;
identifying another global style applied to one or more other content portions of the new document;
matching the other global style to the one or more other content portions;
applying the other global style as another local style to the one or more other content portions;
removing the other global style from the new document; and
merging the new document with the document.

20. The computer-readable memory device of claim 18, wherein the instructions further comprise:
comparing the global CSS applied to the collaboration document with a default CSS associated with the collaboration document;
detecting one or more variances between the global CSS and the default CSS; and
generating the local CSS from the one or more variances.
